(19) United States
(12) Patent Application Publication
(10) Pub. No.: US 2020/0111036 A1
(43) Pub. Date: Apr. 9, 2020

(54) Dynamic Workspace Resource Allocation and Management

(71) Applicant: Jack Gulas, Ottawa (CA)

(72) Inventor: Jack Gulas, Ottawa (CA)

(21) Appl. No.: 16/593,180

(22) Filed: Oct. 4, 2019

Related U.S. Application Data
(60) Provisional application No. 62/741,283, filed on Oct. 4, 2018.

(51) Int. Cl. G06Q 10/06; G06Q 10/04; G06Q 50/16; G06Q 30/02; H04L 12/24

(52) U.S. Cl. CPC G06Q 10/0631; G06Q 10/043; H04L 41/0806; G06Q 30/0206; G06Q 50/167

(57) ABSTRACT

A system, method and device for dynamic workspace resource allocation and management is provided. The system allows users to identify their needs in terms of location, resources and environment of a workspace and identify potentially appropriate workspaces that they can rent. When the user selects a workspace the system can a provision resources such as Wi-Fi, networking and physical access at the site to meet the customer's needs and to automatically revert to the previous configuration or different configuration upon expiration of the rental contract. The provisioning of resources may be a temporary network or virtual network limiting access of the renter to the overall network.

### CROSS-REFERENCE TO RELATED APPLICATIONS

The present application claims priority to U.S. Patent Application No. 62/741,283 filed Oct. 4, 2018 the entirety of which is hereby incorporated for all purposes.

### TECHNICAL FIELD

The present disclosure relates to building facilities and in particular to enabling workspace resource allocation and management to increase utilization.

### BACKGROUND

Commercial real estate is a typically leased by tenants for a period of years. As tenant or company requirements change the need for additional space or the availability of unused space can present challenges in optimizing workspace resources. Current workshare or co-working and office spaces such as WeWork™ are dedicated locations with workspaces and resources which clients can rent individual desks or offices on a short-term basis. When companies have large space which is unutilized there is no current means for them to make that space available to third parties for use on short-term or a dynamic basis. In addition having a way to identify that work spaces available for use to target users and determining an appropriate market price can be difficult. Companies may have, for example, a single desk available or they may have a portion or a whole floor available for relatively short-term use. In addition, the companies may have infrastructure such as telecommunications and networking which is underutilized leading to lost opportunity cost. Accordingly, systems and methods that enable dynamic workspace resource allocation and management remains highly desirable.

### BRIEF DESCRIPTION OF THE DRAWINGS

Further features and advantages of the present invention will become apparent from the following detailed description, taken in combination with the appended drawings, in which:

FIG. 1 shows a system for dynamic workspace allocation and management;

FIG. 2 shows a method of dynamic workspace resource allocation and assignment;

FIG. 3 shows a method of sensor data collection and workspace pricing;

FIG. 4 shows a method of resource utilization determination; and

FIG. 5 shows a method of rating collection and processing.

It will be noted that throughout the appended drawings, like features are identified by like reference numerals.

### DETAILED DESCRIPTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of dynamic workspace resource allocation and management, the method including: determining at a server available workspaces within a plurality of facilities having workspace availability for external assignment; determining resources allocations for each of the workspace; determining resources devices associated with each of the plurality of facilities; posting identification of workspace and associated resource availability to an application server; receiving a request through a network for a user entity for one of the posted workspaces for a defined time period; confirming workspace allocation to the user entity through the network; and provisioning resources of allocated workspaces by sending a configuration assignments to one or more devices at an associated facility. Other embodiments of this aspect include corresponding computer systems, apparatus, and computer programs recorded on one or more computer storage devices, each configured to perform the actions of the methods.

Implementations may include one or more of the following features. The method where determining resource allocations further includes associating one or more usage parameters with each workspace. The method where the one or more usage parameters is selected from a group including security requirements, access hours, parking, guest access, device restrictions, and additional amenities. The method further including receiving resource sensor data of one or more of a plurality of sensors located at the workspace. The method where the sensor includes factors selected from a group including noise, light, temperature, motion, air quality, and network usage. The method further including: determining usage patterns for workspace from the received resource sensor data, determining capacity utilization of workspace and resource devices, recommending resource availability based upon determined capacity utilization, and determining pricing metric for the workspace. The method further including: determining utilization and environmental metrics, modifying devices based upon the determined utilization and environmental metrics, and updating resource usage patterns. The method further including: determining alternate workspace allocations based upon resource usage patterns for a user of the workspace. The method further including: receiving a facility rating from a user; updating a rating index for the facility; determine occupancy and usage metric for associate facility; determine demand factor; and determine resource pricing from ratings, occupancy and usage metric and demand factor. The method where provisioning resources of allocated workspaces includes sending a configuration assignments to one or more devices at the associated facility. The method where the one or more devices is an access control system. The method where the one or more devices is computer network device. The method where the computer network device is a network router. The method where the computer network device is a voice over internet protocol (VOIP) device. The method where the computer network device is an access control device. Implementations of the described techniques may include hardware, a method or process, or computer software on a computer-accessible medium.

One general aspect includes a network device located at an office workspace, the device including: a memory containing instructions; a network interface coupled to a wide area network; and a processor coupled to the memory and network interface, the processor performing instructions stored on the memory for performing. The network device also includes receiving from a configuration file from a provisioning server through the network interface, the configuration file associated with a user entity for a temporary period. The network device also includes configuring one or more network devices within an associated facility to grant access to the office workspace network. The network device also includes configuring one or more access control devices within the facility to grant access to the user. The network device also includes confirming through the network interface that the configuration has been completed. Other embodiments of this aspect include corresponding computer systems, apparatus, and computer programs recorded on one or more computer storage devices, each configured to perform the actions of the methods.

Implementations may include one or more of the following features. The network device further including configuring an environment or lighting control. The network device further including removing the configuration of the one or more network device and one or more access control devices after a defined time period. The network device further including receiving sensor data associated with the workspace and sending the received sensor data to the provisioning server.

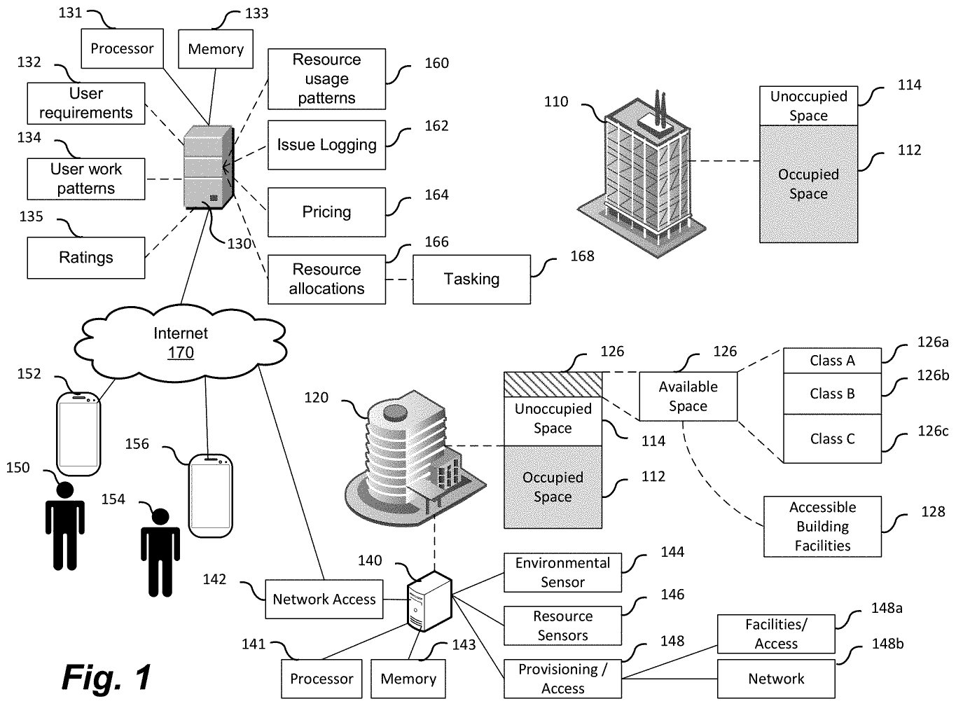

Embodiments are described below, by way of example only, with reference to FIGS. 1-5.

In the commercial real estate environment as users needs change they must adapt their workspace requirements on a regular basis. However, most leasing scenarios are long-term agreements over a number of years which may not provide flexibility to the tenant. In addition, with an increase in the number of agile workers and companies there is a need for office space for a temporary or semi-permanent basis. Traditionally these co-working spaces have been run by companies having dedicated spaces for transient users on a daily weekly or monthly basis such as WeWork. However the accessibility of the spaces can be limited access due to their location and the business model operates on the premise of having tenants in volume and turnover. In the normal operation of a company the amount of workspace that they have versus the amount of workspace that they need can vary considerably over time. A portion of this workspace can be made available to outside parties to use when convenient. The current tenant may have infrastructure such as telecommunications, Wi-Fi™ and networking, that can be provided to any potential workspace user. The problem to existing tenants wanting to provide flexible workspace is that it is difficult to advertise the availability of the space, manage the allocation and provisioning of resources in addition to providing verification of the potential users of the space.

The present system utilizes a management server which can be operated by a dedicated server, a distributed service or a cloud-based service, for managing available workspace across multiple property locations, multiple tenants and multiple property owners. The system allows users to identify their needs in terms of location, resources and environment of a workspace and identify potentially appropriate workspaces that they can rent. When the user selects a workspace the system can a provision resources such as Wi-Fi, networking and physical access at the site to meet the customer's needs and to automatically revert to the previous configuration or different configuration upon expiration of the rental contract. The provisioning of resources may be a temporary network or virtual network limiting access of the renter to the overall network. The workspace allocation may be for a desk, a portion of a floor, or an entire floor or floors and for varying periods of time. The user can provide a rating on the workspace which can be used to identify deficiencies and dynamically determine the pricing that should be applied to the location. The pricing can be based on determination of occupancy (supply and demand), rating of the space, and location. The system enables users, through a computer or mobile application or web interface, to access and select locations and transact a commitment to rent the associated workspace. The workspace can also have integrated sensors to determine occupancy, usage, and environment to better determine resource allocation and any issues at the premises. The workspaces can be assigned across multiple properties of a single owner, multiple owners or tenants within a property, and multiple properties and multiple owners. The application provides a marketplace to the user to select the workspace in which they want to utilize across properties, owners and facilities.

FIG. 1 shows a system for facility resource allocation and management. Facilities 120 and 110 can have space which is occupied 112 by existing tenants. The facility may also have unoccupied space 114 which may not be used by existing tenants or be available within existing tenant spaces. The unoccupied space within the facilities may be made available to other users outside of any existing organization through an electronic application or marketplace identifying the space available and the resources available to the user. The system can provide a user the ability to access a desk, a portion of the floor, or even an entire floor within a building has available office space for short term or long term occupancy. The space that is available may be further differentiated based upon quality of the space or resources that are available to a user of the space. For example in facility 120 a portion of the unoccupied space 126 is available space which may be subdivided into different levels such as class A 126a, class B 126b, and a class C 126c. Each class of space would have potentially different quality, resources or amenities associated with it and it may also have associated shared building facilities 128 that would be accessible to the occupants.

Associated with each premises can be a controlling facility device 140 or multiple devices that can be used to control various aspects of the associated office space. For example environmental sensors 144 can be used to determine occupancy and ingest HVAC or lighting systems. In addition resource sensors 146 may be used to determine usage of office equipment such as photocopiers, wired or wireless networks, telephone systems and amenities of the facility. In addition, the controlling facility device 140, such as a computer having a processor 141 and memory 143 for executing the functions described, has access via a network access device 142 which enables provisioning and access/security controls 148 to be provided facilities 148a and network infrastructure 148b. The facilities 110, 120 are connected to the Internet 170 and a provisioning server 130, or one or more servers, for providing the resource facility resource allocation and management. Users 150 and 154 can access the services provided by the provisioning server 130, having at least a processor 131 and memory 133 for executing the functions described, through an application or web interface which is provided to a computing device such as a user mobile device/phone 152 and 156. The application is hosted on the provisioning server 130 or an associated server and provides functionality for the users 150 and 154 to identify their office space resource requirements and determine available spaces which meet their needs. The provisioning server 130 can collect user requirements 132 and may also collect user work patterns 134 or determine the work patterns by monitoring activity of the location. Users may also provide ratings 135 for facilities that they have used to determine future location suggestions. The provisioning server 130 can also determine users patterns 160 within the facilities to determine utilization and areas within a floorplan that may present an opportunity for further monetization. The application on the user mobile devices 152 and 156 can enable quick identification of issues within the facility, for example lighting problems or network issues, and the system can enable logging 162 of a ticket which can then be tasked for rectification. Pricing 164 can be developed for each facility and modified based upon market conditions, ratings, resources and classification. During the selection process, when a user selects a location they resources can be allocated 166 by tasking 168 resources at the facility such as network access, building access, and environmental systems to user requirements.

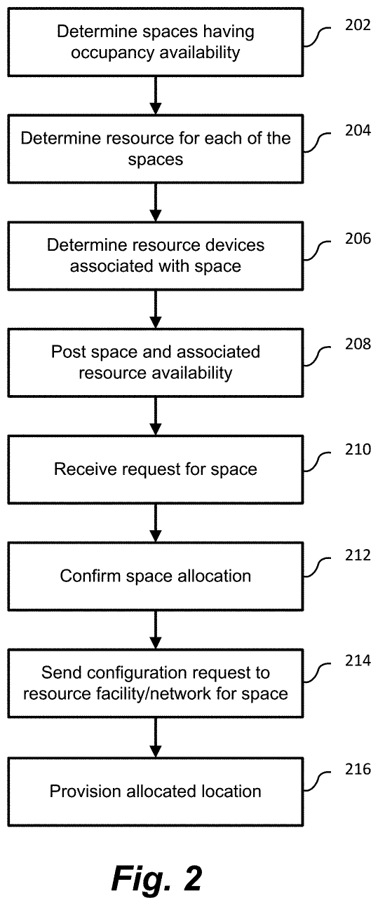

FIG. 2 shows a method of workspace allocation and assignment. At each facility that has workspace available, it is determined if the workspace can be rented to one or more external users (202). The factors for determining if a workspace is available for hire may be dependent on the location of the workspace, the associated security provided at the workspace and the location of the workspace within the existing tenant space or property. Usage parameters based upon requirements of the owner of the space, resources available at this workspace, and the classification of the workspace can be determined (204). Conditions may also be associated with the workspace for example security requirements, access hours, parking, guest access, device restrictions, and additional amenities. The resource devices that are associated with the workspace or portions of the space that are available (206) are determined and the configuration requirements can be associated with those resources. For example, the ability to access networks within the facility and levels and types of security provided at the location may be identified. The workspace is then posted within the application with the conditions for rental and the resources that are available at the facility (208). A user 150 can then select the workspace and define the period and resource requirements (210). The request is processed and may include further verification of the requester identity at which time this workspace can then be confirmed for allocation (212). The configuration requests is then sent to the server associated with the workspace to resource the facility and network devices such as network routes, Voice Over Internet Protocol (VOIP) device, access control device, lighting or environmental controls (214). The space can then be allocated based upon those requirements for the user to use the space during the desired time (216). The configuration and may automatically be removed at the expiry of the contract to time period.

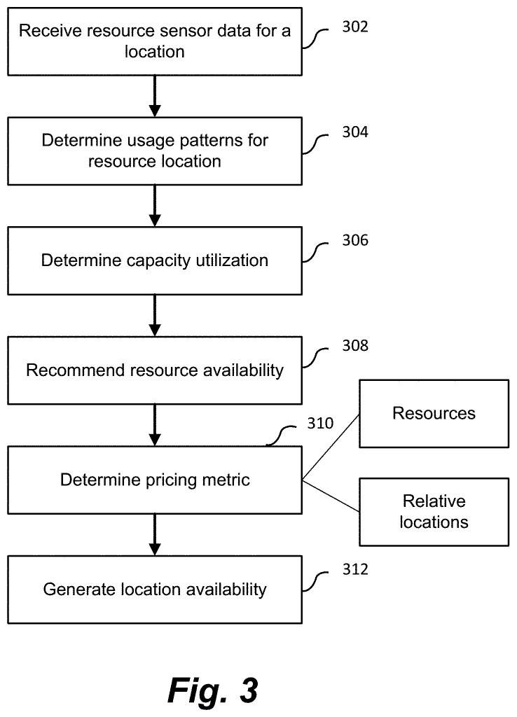

FIG. 3 shows a method of sensor data collection and resource pricing. Sensor data from the workspace (302) for particular resources can be received at the provisioning server (130). Alternatively the sensor data may be aggregated at the facility device 140 and then provided to the server 130. From the data usage patterns for resources at the location can be determined (304), for example occupancy patterns, boardroom usages, photocopier usage, audio video usage, etc. capacity utilization of the facility may also be determined (306) and may identify usage in other currently non-rentable portions of the building to identify additional utilization advantages to the building owner. The system then can then recommend resource availability and modification (308) to the facility or resources within the facility to increase efficiency. A pricing metric can then be determined (310) based upon metric inputs such as amenities or resources that are available at the location in comparison to comparable or relative locations that are nearby or would be considered within the same class space. New location availability can then be generated based upon modifications to the space allocations or resource allocations.

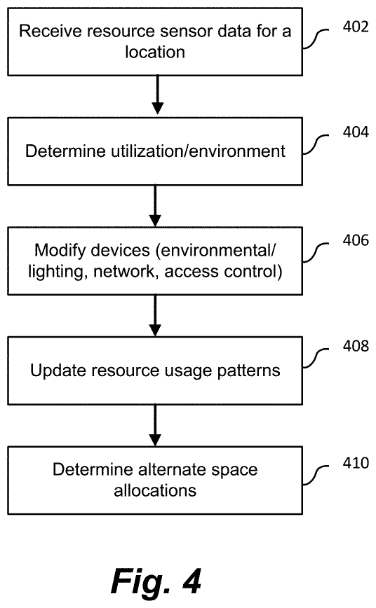

FIG. 4 shows a method of resource utilization determination. Resource sensor data is received for a particular location or area with in a location (402). The utilization and environmental factors can be determined (404) such as for example, noise, light, temperature, motion, air quality, and network usage. Devices or controls can then be modified to meet user requirements or adapt to usage patterns within the environment or based upon pricing conditions (406). Users patterns can then be updated (408) and alternate space allocations can be determined based upon the patterns or requirements if necessary (410).

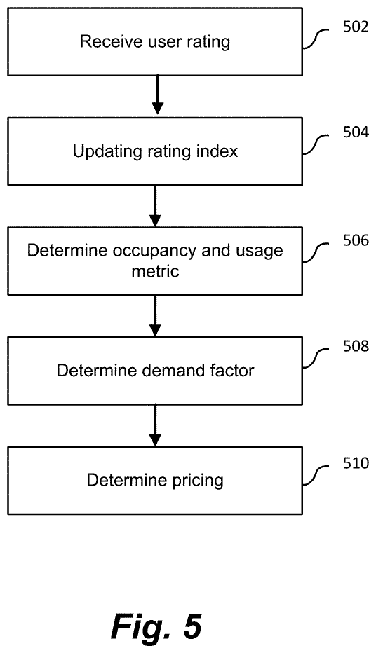

FIG. 5 shows a method of rating collection and processing. A user rating is received (502) through the application. The rating is associated with one or more parameters of the resource location. The ratings can define environmental factors, quality of space, continence, amenities, and location. A rating index associated with the facility is updated to incorporate the user rating (504). The rating can include the quality of the workspace, facilities, common areas, network resources, and environmental factors, etc. Additional metrics such as occupancy and usage can be determined from data associated with the facility (506) and a demand factor is determined (508) for the facility. Pricing for the facility can then be determined (510). The ratings may be received from employees verified to be at the location, or by an administrator associated with the location and then an aggregated submission submitted.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the system and method described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node or device which maybe used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor. to implement one, more or all of the steps of the described method or methods.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Numerous additional variations on the methods and apparatus of the various embodiments described above will be apparent to those skilled in the art in view of the above description. Such variations are to be considered within the scope.

1. A method of dynamic workspace resource allocation and management, the method comprising:
determining at a server available workspaces within a plurality of facilities having workspace availability for external assignment;
determining resources allocations for each of the workspace;
determining resources devices associated with each of the plurality of facilities;
posting identification of workspace and associated resource availability to an application server;
receiving a request through a network for a user entity for one of the posted workspaces for a defined time period;
confirming workspace allocation to the user entity through the network; and
provisioning resources of allocated workspaces by sending a configuration assignments to one or more devices at an associated facility.

2. The method of claim 1 wherein determining resource allocations further comprises associating one or more usage parameters with each workspace.

3. The method of claim 2 wherein the one or more usage parameters is selected from a group comprising security requirements, access hours, parking, guest access, device restrictions, and additional amenities.

4. The method of claim 1 further comprising receiving resource sensor data of one or more of a plurality of sensors located at the workspace.

5. The method of claim 4 wherein the sensor comprises factors selected from a group comprising noise, light, temperature, motion, air quality, and network usage.

6. The method of claim 5 further comprising:
determining usage patterns for workspace from the received resource sensor data;
determining capacity utilization of workspace and resource devices;
recommending resource availability based upon determined capacity utilization; and
determining pricing metric for the workspace.

7. The method of claim 6 further comprising:
determining utilization and environmental metrics;
modifying devices based upon the determined utilization and environmental metrics; and
updating resource usage patterns.

8. The method of claim 6 further comprising:
determining alternate workspace allocations based upon resource usage patterns for a user of the workspace.

9. The method of claim 1 further comprising:
receiving a facility rating from a user;
updating a rating index for the facility;
determine occupancy and usage metric for associate facility;
determine demand factor; and
determine resource pricing from ratings, occupancy and usage metric and demand factor.

10. The method of claim 1 wherein provisioning resources of allocated workspaces comprises sending a configuration assignments to one or more devices at the associated facility.

11. The method of claim 10 wherein the one or more devices is an access control system.

12. The method of claim 10 wherein the one or more devices is computer network device.

13. The method of claim 12 wherein the computer network device is a network router.

14. The method of claim 12 wherein the computer network device is a Voice Over Internet Protocol (VOIP) device.

15. The method of claim 12 wherein the computer network device is an access control device.

16. A non-transitory computer readable memory containing instructions for execution by a processor, the instructions for performing dynamic workspace resource allocation and management, the instructions for performing:
determining at a server available workspaces within a plurality of facilities having workspace availability for external assignment;
determining resources allocations for each of the workspace;
determining resources devices associated with each of the plurality of facilities;
posting identification of workspace and associated resource availability to an application server;
receiving a request through a network for a user entity for one of the posted workspaces for a defined time period;
confirming workspace allocation to the user entity through the network; and
provisioning resources of allocated workspaces by sending a configuration assignments to one or more devices at an associated facility.

17. A network device located at an office workspace, the device comprising:
a memory containing instructions;
a network interface coupled to a wide area network; and
a processor coupled to the memory and network interface, the processor performing instructions stored on the memory for performing:
receiving from a configuration file from a provisioning server through the network interface, the configuration file associated with a user entity for a temporary period;
configuring one or more network devices within an associated facility to grant access to the office workspace network;
configuring one or more access control devices within the facility to grant access to the user; and
confirming through the network interface that the configuration has been completed.

18. The network device of claim 17 further comprising configuring an environment or lighting control.

19. The network device of claim 17 further comprising removing the configuration of the one or more network device and one or more access control devices after a defined time period.

20. The network device of claim 17 further comprising receiving sensor data associated with the workspace and sending the received sensor data to the provisioning server.
